(19) United States
(12) Patent Application Publication
(10) Pub. No.: US 2024/0399472 A1
(43) Pub. Date: Dec. 5, 2024

(54) Ring drill bit with improved drill core removal

(71) Applicant: Hilti Aktiengesellschaft, Schaan (LI)

(72) Inventors: Matthaeus HOOP, Eschen (LI); Marcel SONDEREGGER, Balgach (CH)

(21) Appl. No.: 18/698,319

(22) PCT Filed: Sep. 28, 2022
(86) PCT No.: PCT/EP2022/076894

§ 371 Date: Apr. 3, 2024

(30) Foreign Application Priority Data
Oct. 11, 2021 (EP) 21201907.9

(51) Int. Cl. B23B 51/04

(52) U.S. Cl. CPC B23B 51/0473

(57) ABSTRACT

Ring drill bit including a drilling shaft and a ring segment (22) which is fastened by an underside to an end face of the drilling shaft and which has an inner lateral surface (26). The inner lateral surface (26) has an inner distance (B(φ, h)) from the longitudinal axis (23) perpendicular to the longitudinal axis (23) of the drilling shaft. The inner distance (B(φ, h)) varies in the plane perpendicular to the longitudinal axis (23) and has a first minimum value (B_{min,1}), a first maximum value (B_{max,1}), a second minimum value (B_{min,2}) and a second maximum value (B_{max,2}).

### TECHNICAL FIELD

The present invention relates to a ring drill bit.

### BACKGROUND

In the case of diamond tools which are designed as drill bits for core drilling, a distinction is made between ring drill bits having a closed ring segment and segmented drill bits having a plurality of drilling segments. Here, ring drill bits are used in particular for drill bits having small diameters of up to about 50 mm, and segmented drill bits are used for drill bits having diameters starting from 35 mm. Owing to a larger attachment surface between the ring segment and the drilling shaft, ring drill bits have a higher mechanical stability during the drilling operation than segmented drill bits, whereas, with the design of the drilling segments for segmented drill bits, the advantages of set diamond particles can be utilized.

Known ring drill bits comprise a drilling shaft with a shank and a ring segment which is fastened by an underside to an end face of the drilling shaft; the ring drill bit can be fastened in the tool fitting of a core drilling device via the shank. The drilling shaft has a cylinder with a longitudinal axis, and the ring segment has an inner lateral surface and an outer lateral surface, wherein the inner lateral surface is cylindrical and has a constant inner distance from the longitudinal axis in a plane perpendicular to the longitudinal axis.

When drilling a substrate, for example a wall, a concrete wall or a concrete floor, a drill core is obtained in the interior of the drill bit and has to be removed from the drill bit after drilling, with it being possible that problems may occur and the drill core jams in the interior. Particular problems are caused by fragments which break out of the drill core and can jam between the drill bit and drill core.

### SUMMARY OF THE INVENTION

An object of the present invention is to develop a ring drill bit having a ring segment in which the risk of jamming drill cores is reduced. In addition, it is intended for the removal of a jamming drill core to be simplified.

The present invention provides a ring drill bit comprising
a drilling shaft (21) which has a cylinder (24) with a longitudinal axis (23), wherein the cylinder (24), in a plane (25) perpendicular to the longitudinal axis (23), has an outside diameter (da), an inside diameter (di) and a shaft width (b), and
a ring segment (22; 42) which is fastened by an underside (28; 48) to an end face (31) of the drilling shaft (21) and which has an inner lateral surface (26; 46) which has an inner distance (B (q, h)) from the longitudinal axis (23) perpendicular to the longitudinal axis (23) of the drilling shaft (21).

The ring drill bit is characterized according to the invention in that the inner distance has a first minimum value, a second minimum value, a first maximum value and a second maximum value in the circumferential direction, wherein the first maximum value is arranged between the first minimum value and second minimum value in the circumferential direction, and the second maximum value is arranged between the second minimum value and first minimum value in the circumferential direction.

In the ring drill bit according to the invention, the inner distance of the inner lateral surface varies between the minimum and maximum values over the circumference of the ring segment. Here, the smallest inner distance from the longitudinal axis determines the core diameter of the drill core, which corresponds to double the smallest inner distance. The variation of the inner distance over the circumference of the ring segment allows the contact surface of the ring segment with respect to the drill core to be reduced and the friction between the ring segment and the drill core to be reduced. The distribution of the first and second minimum values and of the first and second maximum values over the circumference of the ring segment makes it possible to pro-duce ring segments in which a gap is formed between the ring segment and the drill core over a partial circumference of the ring segment during the drilling operation, which gap reduces the risk of jamming drill cores and can facilitate the removal of a jamming drill core. The ring segment should have at most two minimum values with the same smallest inner distance.

Preferably, the first minimum value and the second minimum value correspond. A ring segment in which the first minimum value and the second minimum value of the inner distance correspond within the manufacturing tolerances achieves uniform abrasive removal during the drilling operation and can reduce vibrations of the ring drill bit.

Preferably, the first minimum value and the second minimum value are offset from one another by 180° in the circumferential direction. With an offset of about 180°, the first and second minimum value are situated opposite one another in the circumferential direction and lead, in particular in the case of ring segments with corresponding first and second minimum values, to a mirror-symmetrical design of the inner lateral surface. The mirror-symmetrical design makes it possible for vibrations of the ring drill bit during the drilling operation to be reduced and the running smoothness of the ring drill bit can be improved.

Preferably, the inner distance, over the circumference of the ring segment, describes a mathematical function which follows a strictly monotonic profile in the region of the first minimum value and of the second minimum value. A strictly monotonic profile of the inner distance in the region of the minimum values makes it possible for the contact surface of the ring segment with respect to the drill core to be reduced and the friction between the ring segment and the drill core to be reduced. In addition, the regions in which the drill core can jam are further reduced.

Preferably, the first maximum value and the second maximum value correspond. A ring segment in which the first maximum value and the second maximum value of the inner distance correspond within the manufacturing tolerances achieves uniform abrasive removal during the drilling operation and can reduce vibrations of the ring drill bit.

Preferably, the first maximum value and the second maximum value are offset from one another by 180° in the circumferential direction. With an offset of 180°, the first and second maximum value are situated opposite one another in the circumferential direction. This distribution of the first and second maximum values over the circumference of the ring segment enables the production of ring segments in which a gap is formed between the ring segment and the drill core over a partial circumference during the drilling operation, wherein the maximum gap is present in the region of the maximum inner distances. A jamming drill core can be moved in the ring segment by the operator, with the result that the removal of a jamming drill core is facilitated.

Particularly preferably, the inner lateral surface of the ring segment, in the plane perpendicular to the longitudinal axis of the drilling shaft, has an elliptical shape with a short semiaxis and a long semiaxis, wherein the first and second minimum value form the short semiaxis, and the first and second maximum value form the long semiaxis. The elliptical shape of the inner lateral surface enables a strictly monotonic profile of the inner distance in the region of the minimum values.

In a first variant, the inner lateral surface of the ring segment is formed as a cylinder with a base surface which differs from a circular shape. The formation of the inner lateral surface as a cylinder has the advantage that the abrasive removal properties of the ring segment are constant over the height. By using a cylinder with a noncircular base surface, the contact surface between the ring segment and the drill core can be reduced. Particularly preferably, the base surface has an elliptical shape; the elliptical shape is particularly suitable as a noncircular base surface.

In a second variant, the inner lateral surface of the ring segment is formed as an inner cone which tapers in the direction of an upper side opposite to the underside of the ring segment. A ring segment whose inner lateral surface is formed as an inner cone with a noncircular base surface has the advantage that the contact surface is further reduced and the friction between the ring segment and the drill core is reduced. By virtue of the fact that the inner cone tapers in the direction of the upper side of the ring segment, the removal of a jamming drill core can be facilitated. The risk of the drill core jamming in the ring segment is greatest in the region of the smallest inner distance. Since the upper side of the ring segment is accessible for the operator, the operator can remove the jamming drill core.

Preferably, the inner cone has a base surface which differs from a circular shape. Particularly preferably, the base surface has an elliptical shape; the elliptical shape is particularly suitable as a noncircular base surface.

### BRIEF DESCRIPTION OF THE DRAWINGS

Exemplary embodiments of the invention are described hereinafter with reference to the drawing. It is not necessarily intended for this to represent the exemplary embodiments to scale; rather, the drawing is produced in a schematic and/or slightly distorted form where useful for the purposes of explanation. It should be taken into account here that a wide variety of modifications and alterations relating to the form and detail of an embodiment may be undertaken without departing from the general concept of the invention. The general concept of the invention is not limited to the exact form or the detail of the preferred embodiments shown and described hereinafter or limited to subject matter which would be restricted compared with the subject matter claimed in the claims. For given dimensioning ranges, values within the stated limits are also intended to be disclosed as limit values and should be able to be used and claimed as desired. For the sake of simplicity, the same reference signs are used hereinafter for identical or similar parts or parts having an identical or similar function.

In the drawing:

FIG. 1 shows a ring drill bit according to the invention having a drilling shaft and a ring segment which is fastened to the drilling shaft;

FIGS. 2A, B show a ring drill bit according to the invention having a drilling shaft and a first embodiment of a ring segment in a longitudinal section parallel to the longitudinal axis of the drilling shaft (FIG. 2A) and the ring segment in a cross section perpendicular to the longitudinal axis of the drilling shaft (FIG. 2B); and

FIGS. 3A, B show a second embodiment of the ring segment in a longitudinal section parallel to the longitudinal axis of the drilling shaft (FIG. 3A) and a cross section perpendicular to the longitudinal axis of the drilling shaft (FIG. 3B).

### DETAILED DESCRIPTION

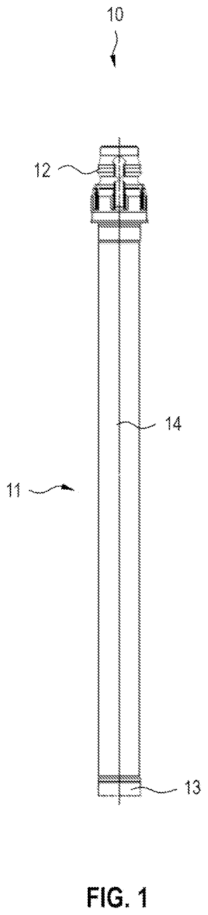

FIG. 1 shows a ring drill bit 10 which has a drilling shaft 11 with a shank 12 and a closed ring segment 13. The ring drill bit 10 is fastened in the tool fitting of a core drilling device via the shank 12 and, during the drilling operation, is driven by the core drilling device about an axis of rotation which runs coaxially with the longitudinal axis 14 of the drilling shaft 11.

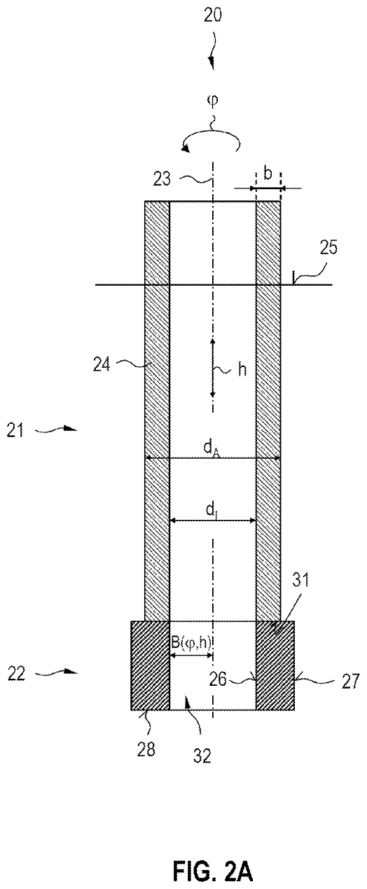

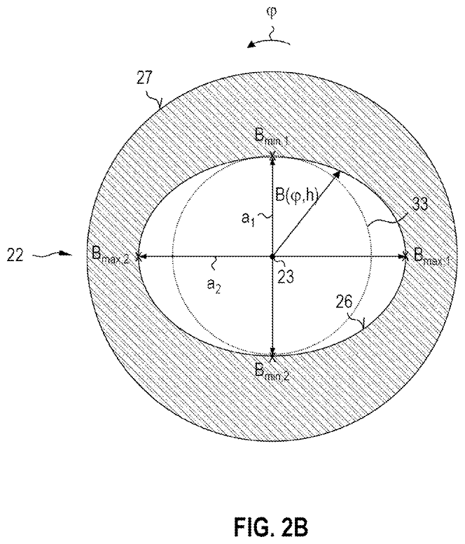

FIGS. 2A, B show a drill bit 20 according to the invention which has a drilling shaft 21 and a ring segment 22. In this case, FIG. 2A shows the drilling shaft 21 and the ring segment 22 in a longitudinal section parallel to the longitudinal axis 23 of the drilling shaft 21, and FIG. 2C shows the ring segment 22 in a cross section perpendicular to the longitudinal axis 23 of the drilling shaft 21.

The drilling shaft 21 comprises a cylinder 24 which, in a plane 25 perpendicular to the cylinder axis, which defines the longitudinal axis 23 of the drilling shaft 21, has an outside diameter da, an inside diameter di and a shaft width b. In the exemplary embodiment, the inside diameter di, the outside diameter da and the shaft width b are constant both in a circumferential direction q and in a height direction h. Alternatively, the inside diameter, the outside diameter and/or the shaft width can vary in the circumferential direction q and/or in the height direction h.

The ring segment 22 comprises an inner lateral surface 26, an outer lateral surface 27, an underside 28 and an upper side 29, wherein the ring segment 22 is fastened by the underside 28 to an end face 31 of the drilling shaft 21. The inner lateral surface 26 is formed as a cylinder 32 with a base surface which differs from a circular shape. The formation of the inner lateral surface 26 as a cylinder has the advantage that the abrasive removal properties of the ring segment 22 are constant over the height.

The inner lateral surface 26 has an inner distance B (9, h) from the longitudinal axis 23 in the plane 25 perpendicular to the longitudinal axis 23. Here, the inner distance B (q, h) defines a mathematical function which describes the profile of the inner distance over the circumference and the height of the ring segment 22. The inner distance B (q, h) varies between two minimum values and two maximum values in the circumferential direction q over the circumference of the ring segment 22; the inner distance B (q, h) is constant in the height direction h. In the plane 25 perpendicular to the longitudinal axis 23, the inner distance B (φ, h) has a first minimum value B_{min,1}, a first maximum value B_{max,1}, a second minimum value B_{min,2} and a second maximum value B_{max,2}.

In the exemplary embodiment, the first minimum value B_{min,1} and second minimum value B_{min,2} are offset from one another by about 180° in the circumferential direction q, and the first maximum value B_{max,1} and second maximum value B_{max,2} are like-wise offset from one another by about 180° in the circumferential direction. With an offset of about 180°, the minimum values B_{min,1}, B_{min,2} and the maximum values B_{max,1}, B_{max,2} are situated opposite one another in the circumferential direction q and lead to a mirror-symmetrical design of the inner lateral surface 26. The symmetrical design makes it possible for vibrations of the drill bit 20 to be reduced during the drilling operation and the running smoothness of the drill bit 20 to be improved.

FIG. 2B shows the ring segment 22 and a drill core 33, which is produced by the drill bit 20 during the drilling operation, in cross section perpendicular to the longitudinal axis 23 of the drilling shaft 21. The smallest inner distance of the inner lateral surface 26 from the longitudinal axis 23 determines the core diameter, which corresponds to double the smallest inner distance. The variation of the inner distance B (q, h) makes it possible for the contact surface with respect to the drill core 33 to be reduced and the friction between the ring segment 22 and the drill core 33 to be reduced.

The distribution of the first and second minimum values B_{min,1}, B_{min,2} and of the first and second maximum values B_{max,1}, B_{max,2} over the circumference of the ring segment 22 enables the production of ring segments in which a gap is formed between the ring segment 22 and the drill core 33 during the drilling operation, which gap reduces the risk of jamming drill cores and facilitates the removal of a jamming drill core.

In the exemplary embodiment, the inner lateral surface 26, in the plane 25 perpendicular to the longitudinal axis 23, has an elliptical shape with a short semiaxis a₁ and a long semiaxis a₂, wherein the first and second minimum value B_{min,1}, B_{min,2} form the short semiaxis a₁, and the first and second maximum value B_{max,1}, B_{max,2} form the long semiaxis a₂. The elliptical shape is particularly suitable as a noncircular base surface of the cylinder 32.

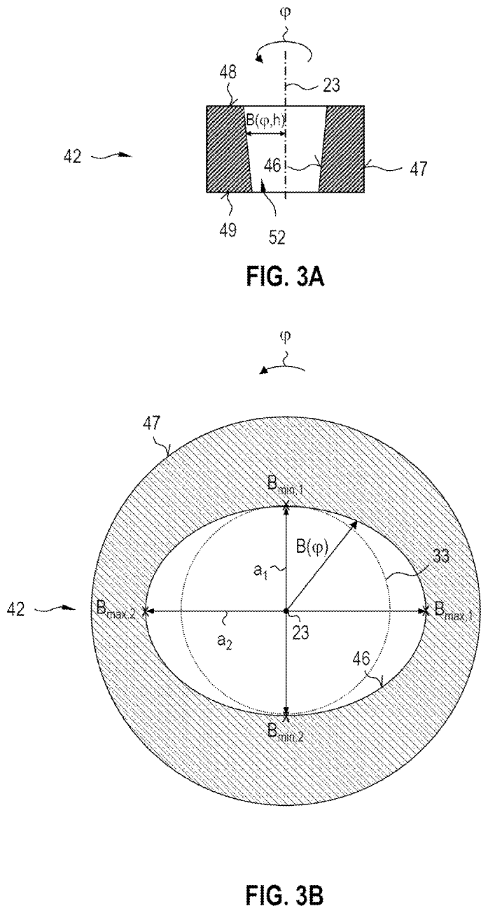

FIGS. 3A, B show a second embodiment of a ring segment 42 for the drill bit 20 in a longitudinal section parallel to the longitudinal axis 23 of the drilling shaft 21 (FIG. 3A) and in a cross section perpendicular to the longitudinal axis 23 of the drilling shaft 21 (FIG. 3B). The ring segment 42 differs from the ring segment 22 through the configuration of the inner lateral surface.

The ring segment 42 comprises an inner lateral surface 46, an outer lateral surface 47, an underside 48 and an upper side 49, wherein the ring segment 42 is fastened by the underside 48 to the end face 31 of the drilling shaft 21. The inner lateral surface 46 is formed as an inner cone 52 with a base surface which differs from a circular shape, wherein the inner cone 52 tapers in the direction of the upper side 49 of the ring segment 42.

The formation of the inner lateral surface 46 as an inner cone 52 with a noncircular base surface has the advantage that the contact surface between the ring segment 42 and the drill core 33 can be reduced. The tapering of the inner cone in the direction of the upper side 49 of the ring segment 42 makes it possible for the removal of a jamming drill core to be facilitated. The risk of the drill core jamming in the ring segment 42 is greatest in the region of the smallest inner distance. Since the upper side 49 of the ring segment 42 is accessible for the operator, the operator can release and remove the jamming drill core.

The inner lateral surface 46 of the ring segment 42 has an inner distance B (9, h) from the longitudinal axis 23 in the plane 25 perpendicular to the longitudinal axis 23. Here, the inner distance B (q, h) defines a mathematical function which describes the profile of the inner distance over the circumference and the height of the ring segment 42. The inner distance B (q, h) varies between two minimum values and two maximum values in the circumferential direction q over the circumference of the ring segment 42; the inner distance B (q, h) varies in the height direction h and decreases in the direction of the upper side 49 of the ring segment 42. In the plane 25 perpendicular to the longitudinal axis 23, the inner distance B (q, h) has a first minimum value B_{min,1}, a first maximum value B_{max,1}, a second minimum value B_{min,2} and a second maximum value B_{max,2}.

In the exemplary embodiment, the first minimum value B_{min,1} and second minimum value B_{min,2} are offset from one another by about 180° in the circumferential direction q, and the first maximum value B_{max,1} and second maximum value B_{max,2} are like-wise offset from one another by about 180° in the circumferential direction. With an offset of about 180°, the minimum values B_{min,1}, B_{min,2} and the maximum values B_{max,1}, B_{max,2} are situated opposite one another in the circumferential direction q and lead to a mirror-symmetrical design of the inner lateral surface 46. The symmetrical design makes it possible for vibrations of the drill bit 20 to be reduced during the drilling operation and the running smoothness of the drill bit 20 to be improved.

What is claimed is:

1-10. (canceled)

11. A ring drill bit comprising:
a drilling shaft having a cylinder with a longitudinal axis, wherein the cylinder, in a plane perpendicular to the longitudinal axis, has an outside diameter, an inside diameter and a shaft width; and
a ring segment fastened by an underside to an end face of the drilling shaft and having an inner lateral surface having an inner distance from the longitudinal axis perpendicular to the longitudinal axis of the drilling shaft,
the inner distance having a first minimum value, a second minimum value, a first maximum value and a second maximum value in a circumferential direction, wherein the first maximum value is arranged between the first minimum value and second minimum value in the circumferential direction, and the second maximum value is arranged between the second minimum value and first minimum value in the circumferential direction.

12. The ring drill bit as recited in claim 11 wherein the first minimum value and the second minimum value correspond.

13. The ring drill bit as recited in claim 11 wherein the first minimum value and the second minimum value are offset from one another by about 180° in the circumferential direction.

14. The ring drill bit as recited in claim 11 wherein the inner distance, over the circumference of the ring segment, follows a strictly monotonic profile in the region of the first minimum value and of the second minimum value.

15. The ring drill bit as recited in claim 11 wherein the first maximum value and the second maximum value correspond.

16. The ring drill bit as recited in claim 11 wherein the first maximum value and the second maximum value are offset from one another by about 180° in the circumferential direction.

17. The ring drill bit as recited in claim 16 wherein the inner lateral surface, in the plane perpendicular to the longitudinal axis of the drilling shaft, has an elliptical shape with a short semiaxis and a long semiaxis, wherein the first and second minimum value define the short semiaxis, and the first and second maximum value define the long semiaxis.

18. The ring drill bit as recited in claim 11 wherein the inner lateral surface is formed as a cylinder with a base surface differing from a circular shape.

19. The ring drill bit as recited in claim 11 wherein the inner lateral surface is formed as an inner cone tapering in the direction of an upper side opposite to the underside of the ring segment.

20. The ring drill bit as recited in claim 19 wherein the inner cone has a base surface differing from a circular shape.
